(19) United States
(12) Patent Application Publication
(10) Pub. No.: US 2008/0085032 A1
(43) Pub. Date: Apr. 10, 2008

(54) SUPPLYING DIGITAL IMAGES FROM A COLLECTION

(76) Inventors: Cathleen D. Cerosaletti, Rochester, NY (US); Alexander C. Loui, Penfield, NY (US)

Correspondence Address: Patent Legal Staff;Eastman Kodak Company, 343 State Street, Rochester, NY, 14650-2201, US

(21) Appl. No.: 11/747,933

(22) Filed: May 14, 2007

Related U.S. Application Data
(60) Provisional application No. 60/828,494, filed on Oct. 6, 2006.

(51) Int. Cl. G06K 9/00

(52) U.S. Cl. 382/100

(57) ABSTRACT

In a computer-mediated method and a system for supplying image records from a collection, an output request is received from a user. An output is generated responsive to the request by locating a set of image records in the collection corresponding to the request, determining one or more constraints on the output, ascertaining a respective value index of each of the image records in the set, calculating a statistical measure of the value indexes of the set, reducing in number the image records in the set responsive to the constraints while optimizing the statistical measure to provide a reduced set of image records, and providing the output using the reduced set of image records.

### CROSS REFERENCE TO RELATED APPLICATIONS

This is a 111A Application of Provisional Application Ser. No. 60/828,494, filed on Oct. 6, 2006.

Reference is made to commonly assigned, co-pending U.S. patent application Ser. No. ______, [Attorney Docket No. 92807], entitled: DIFFERENTIAL CLUSTER RANKING FOR IMAGE RECORD ACCESS, filed May 9, 2007, in the names of Cathleen D. Cerosaletti, Sharon Field, and Alexander C. Loui.

### FIELD OF THE INVENTION

The invention relates to management and organization of digital image records and more particularly relates to methods and apparatus for supplying digital image records from a collection.

### BACKGROUND OF THE INVENTION

The proliferation of digital cameras and scanners has lead to an enormous number of digital images and videos (“image records”), creating image record collections that are inefficient to manually browse and search. A further problem is presented by the myriad of different ways that a user can access an image record collection, particularly a collection stored on a remote system database. For example, a user can access image records in a collection for viewing on a cell phone, a portable terminal having a larger display than a cell phone, and on a personal computer or home entertainment system having a still larger display. Similarly, a user can access image records for printing on any of a variety of printers or for transfer as a digital file. Further issues are created by the different characteristics of image records in the collection resulting from capture and/or transmission from different devices, such as cell phone cameras, portable media players, and personal computers.

The different devices used to access a remote database can have different characteristics. For example, a cell phone connects through a cellular network and publically switched telephone network. A portable terminal connects through a local radio-frequency network. A personal computer can connects through a broadband connection. Each of these devices can have different constrains. Examples of such constraints include a display resolution and available bandwidth for transfer of images from the remote database. The user can have different requirements or constraints at different times. An example of such constraints is the time available to the user to review images on the different devices. For a particular user, the cell phone may be more likely to be used quickly while standing or walking, the portable terminal while seated for a slightly longer period, and the personal computer for an extended period of time. Despite these constraints, the same query presented to the database from each of these devices would present the same results. This can be problematic.

U.S. Pat. No. 6,285,788 to Sezan et al. discloses a method, in which individual images returned in response to a query are abstracted to reduce the amount of information to be transmitted in a limited bandwidth environment. The level of abstraction used is the highest (least details) that will supply less images than a user selected number in response to the query. The user can then select a subset, which are then sent with less abstraction (more details). The selection of a subset can be iterated. A shortcoming of this approach is that it assumes that the user is seriously searching for particular images. The need to iteratively review abstracted, lower resolution images would tend to deter casual use. U.S. Pat. Nos. 6,356,658 and 6,925,207, both to Sezan et al. are similar.

It would thus be desirable to provide methods and systems that do not have these shortcomings.

### SUMMARY OF THE INVENTION

The invention is defined by the claims. The invention, in broader aspects, provides a computer-mediated method and a system for supplying image records from a collection. In the method and system, an output request is received from a user. An output is generated responsive to the request by locating a set of image records in the collection corresponding to the request, determining one or more constraints on the output, ascertaining a respective value index of each of the image records in the set, calculating a statistical measure of the value indexes of the set, reducing in number the image records in the set responsive to the constraints while optimizing the statistical measure to provide a reduced set of image records, and providing the output using the reduced set of image records.

It is an advantageous effect of the invention that improved methods and systems are provided in which image records are supplied from a collection taking into account constraints associated with a particular output.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a diagram of an embodiment of the method.

FIG. 2 is a semi-diagrammatical view of an embodiment of the system.

FIG. 3 is a semi-diagrammatical view of another embodiment of the system.

FIG. 4 is a semi-diagrammatical view of the clustering in an embodiment of the method.

FIG. 5 is a semi-diagrammatical view of the clustering in another embodiment of the method.

FIG. 6 is a more detailed diagram of the embodiment of FIG. 1.

FIG. 7 is a diagrammatical view of the output provided by the system of FIG. 2 or 3 in response to the same request of the same collection, but with different constraints.

### DETAILED DESCRIPTION OF THE INVENTION

Device limitations impact the user's ability to effectively browse and search image collections. Device limitations include one or more of hardware limitations including memory and CPU power; user input methods including mouse, gesture-based systems, voice-input, other pointing devices, touch screen; display limitations including resolution, size, color resolution, and brightness range; network and communication bandwidth limitations. The invention provides a method and system for providing results of a query to a database of image records to vary in terms of number of image records, dependent upon constraints associated with a particular output. Those constraints can be due to characteristics of a device or particular communication path or can be due to the manner in which the user interacts with that device or path. For example, the query “let me see my grandchildren” can provide a small number of images to a cell phone, a moderate number to a portable terminal, and a large number or all available to a personal computer.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like is not limiting.

The term “image record” is used herein to refer to a digital still image, video sequence, or multimedia record. An image record is inclusive of one or more digital images and can also include metadata, such as sounds or textual annotations. A particular image record can be a single digital file or multiple, but associated digital files. Metadata can be stored in the same image file as the associated digital image or can be stored separately. Examples of image records include multiple spectrum images, scannerless range images, digital album pages, and multimedia video presentations. With a video sequence, the sequence of images is a single image record. Each of the images in a sequence can alternatively be treated as a separate image record. Discussion herein is generally directed to image records that are captured using a digital camera. Image records can also be captured using other capture devices and by using photographic film or other means and then digitizing. As discussed herein, image records are stored digitally along with associated information.

The term “subject” is used in a photographic sense to refer to one or more persons or other items in a captured scene that as a result of perspective and/or range data are distinguishable from the remainder of the scene, referred to as the background. Perspective is inclusive of such factors as: linear perspective (convergence to a vanishing point), overlap, depth of field, lighting and color cues, and, in appropriate cases, motion perspective and motion parallax.

In the following description, some features are described as “software” or “software programs”. Those skilled in the art will recognize that the equivalent of such software can also be readily constructed in hardware. Because image manipulation algorithms and systems are well known, the present description emphasizes algorithms and features forming part of, or cooperating more directly with, the method. General features of the types of computerized systems discussed herein are well known, and the present description is generally limited to those aspects directly related to the method of the invention. Other aspects of such algorithms and apparatus, and hardware and/or software for producing and otherwise processing the image signals involved therewith, not specifically shown or described herein may be selected from such systems, algorithms, components, and elements known in the art. Given the description as set forth herein, all additional software/hardware implementation is conventional and within the ordinary skill in the art.

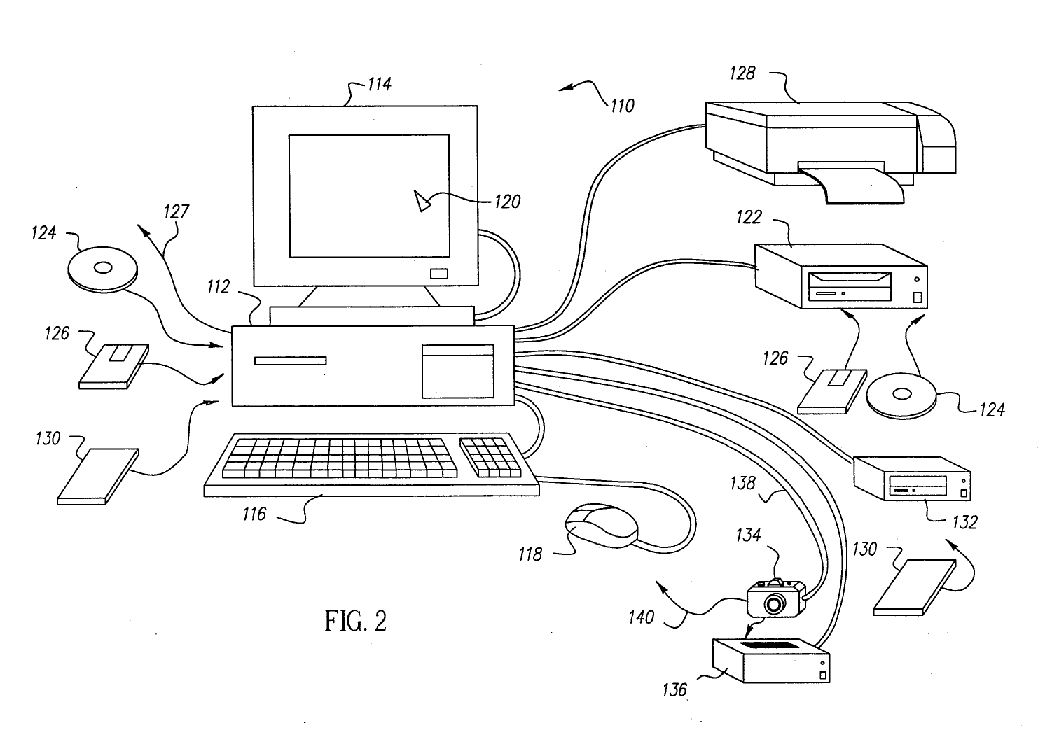

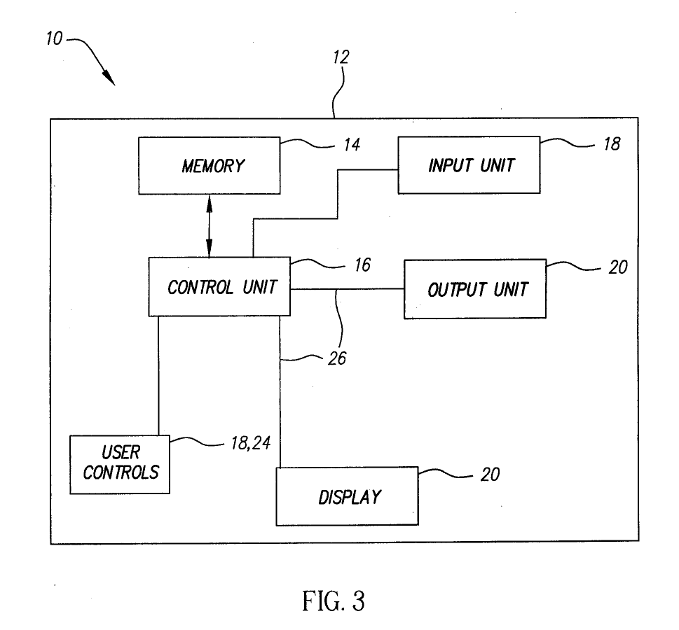

FIG. 3 illustrates an embodiment of the system. The system 10 has a housing 12, memory 14 having a collection of image records, a control unit 16, input units 18 (including user controls) and output units 20 (including a display) connected to the control unit 16. The system 10 has a user interface 22 that includes user controls 24 and can include some or all of the input and output units 18, 20. Components are connected by signal paths 26 and, in this embodiment, the system components and signal paths are located within the housing 12 as illustrated. In other embodiments, one or more components and signal paths can be located in whole or in part outside of the housing. The present invention can be implemented in computer hardware and computerized equipment. For example, the method can be performed using a system including one or more digital cameras or other capture devices and/or one or more personal computers. FIG. 2 illustrates another embodiment, in which the system includes a general purpose computer and various peripherals. The present invention is not limited to the computer system 110 shown, but may be used with any electronic processing system such as found in digital cameras, cellular camera phones and other mobile devices, home computers, kiosks, retail or wholesale photofinishing, or any other system for the processing of digital images. Different components of the system can be completely separate or can share one or more hardware and/or software features with other components.

The control unit operates the other components of the system utilizing stored software and data based upon signals from the input units. The control unit can include, but is not limited to, a programmable digital computer, a programmable microprocessor, a programmable logic processor, a series of electronic circuits, a series of electronic circuits reduced to the form of an integrated circuit, or a series of discrete components.

In addition to functions necessary to operate the system, the control unit can manipulate image records according to software programs stored in memory either automatically or with user intervention. For example, a digital still image can be processed by the digital signal processor to provide interpolation and edge enhancement. Similarly, an image record may need to be transformed to accommodate different output capabilities, such as gray scale, color gamut, and white point of a display. The displayed image can be cropped, reduced in resolution and/or contrast levels, or some other part of the information in the image may not be shown. Modifications related to file transfer, can include operations such as, JPEG compression and file formatting. Other enhancements can also be provided. The image modifications can also include the addition or modification of metadata, that is, image record associated non-image information.

“Memory” refers to one or more suitably sized logical units of physical memory provided in semiconductor memory or magnetic memory, or the like. Memory of the system can store a computer program product having a program stored in a computer readable storage medium. Memory can include conventional memory devices including solid state, magnetic, optical or other data storage devices and can be fixed within system or can be removable. For example, memory can be an internal memory, such as, such as SDRAM or Flash EPROM memory, or alternately a removable memory, or a combination of both. Removable memory can be of any type, such as a Secure Digital (SD) type card inserted into a socket and connected to the control unit via a memory interface. Other types of storage that are utilized include without limitation PC-Cards and embedded and/or removable hard drives. In the embodiment of FIG. 2, system is shown having a hard drive, a disk drive for a removable disk such as an optical, magnetic or other disk memory (not shown) and a memory card slot that holds a removable memory, such as a removable memory card and has a removable memory interface for communicating with removable memory. Data including but not limited to control programs, digital images and other image records, and metadata can also be stored in a remote memory system such as a personal computer, computer network or other digital system.

The input units can comprise any form of transducer or other device capable of receiving an input from a user and converting this input into a form that can be used by the control unit. Similarly, the output units can comprise any form of device capable of delivering an output in human perceptible form or in computer readable form as a signal or as part of a computer program product. Input and output units can be local or remote. A wired or wireless communications system that incorporates hardware and software of one or more input and output units can be included in the system.

The input units of the user interface can take a variety of forms. For example, the user interface can comprise a touch screen input, a touch pad input, a 4-way switch, a 6-way switch, an 8-way switch, a stylus system, a trackball system, a joystick system, a voice recognition system, a gesture recognition system a keyboard, a remote control or other such systems. The user interface can include an optional remote input, including a remote keyboard and a remote mouse.

Input devices can include one or more sensors, which can include light sensors, biometric sensors and other sensors known in the art that can be used to detect conditions in the environment of system and to convert this information into a form that can be used by control unit of the system. Light sensors can include one or more ordinary cameras and/or multispectral sensors. Sensors can also include audio sensors that are adapted to capture sounds. Sensors can also include biometric or other sensors for measuring involuntary physical and mental reactions such sensors including but not limited to voice inflection, body movement, eye movement, pupil dilation, body temperature, and p4000 wave sensors.

Output units can also vary widely. In a particular embodiment, the system includes a display, a printer, and a memory writer as output units. The printer can record images on receiver medium using a variety of known technologies including, but not limited to, conventional four color offset separation printing or other contact printing, silk screening, dry electrophotography such as is used in the NexPress 2500 printer sold by Eastman Kodak Company, Rochester, N.Y., USA, thermal printing technology, drop on demand ink jet technology and continuous inkjet technology. For the purpose of the following discussions, the printer will be described as being of a type that generates color images on a paper receiver; however, it will be appreciated that this is not necessary and that the claimed methods and apparatuses herein can be practiced with a printer that prints monotone images such as black and white, grayscale or sepia toned images and with a printer that prints on other types of receivers.

A communication system can comprise for example, one or more optical, radio frequency or other transducer circuits or other systems that convert image and other data into a form that can be conveyed to a remote device such as remote memory system or remote display device 56 using an optical signal, radio frequency signal or other form of signal. Communication system 54 can also be used to receive a digital image and other data from a host or server computer or network (not shown), a remote memory system 52 or a remote input 58. Communication system 54 provides control unit 34 with information and instructions from signals received thereby. Typically, communication system 54 will be adapted to communicate with the remote memory system 52 by way a communication network such as a conventional telecommunication or data transfer network such as the Internet, a cellular, peer-to-peer or other form of mobile telecommunication network, a local communication network such as wired or wireless local area network or any other conventional wired or wireless data transfer system.

A source of image records can be provided in the system. The source of image records can include any form of electronic or other circuit or system that can supply the appropriate digital data to the control unit. The source of image records can be a camera or other capture device that can capture content data for use in image records and/or can obtain image records that have been prepared by or using other devices. For example, a source of image records can comprise a set of docking stations, intermittently linked external digital capture and/or display devices, a connection to a wired telecommunication system, a cellular phone and/or a wireless broadband transceiver providing wireless connection to a wireless telecommunication network. As other examples, a cable link provides a connection to a cable communication network and a dish satellite system provides a connection to a satellite communication system. An Internet link provides a communication connection to a remote memory in a remote server. A disk player/writer provides access to content recorded on an optical disk.

Referring to FIG. 2, the computer system 110 includes a control unit 112 for receiving and processing software programs and for performing other processing functions. A display 114 is electrically connected to the control unit 112 for displaying user-related information associated with the software, e.g., by means of a graphical user interface. A keyboard 116 is also connected to the control unit 112 for permitting a user to input information to the software. As an alternative to using the keyboard 116 for input, a mouse 118 may be used for moving a selector 120 on the display 114 and for selecting an item on which the selector 120 overlays, as is well known in the art.

Removable memory, in any form, can be included and is illustrated as a compact disk-read only memory (CD-ROM) 124, which can include software programs, is inserted into the microprocessor based unit for providing a means of inputting the software programs and other information to the control unit 112. Multiple types of removable memory can be provided (illustrated here by a floppy disk 126) and data can be written to any suitable type of removable memory. Memory can be external and accessible using a wired or wireless connection, either directly or via a local or large area network, such as the Internet. Still further, the control unit 112 may be programmed, as is well known in the art, for storing the software program internally. A printer or other output device 128 can also be connected to the control unit 112 for printing hardcopy output from the computer system 110. The control unit 112 can have a network connection 127, such as a telephone line or wireless link, to an external network, such as a local area network or the Internet.

Images can be obtained from a variety of sources, such as a digital camera or a scanner. Images can also be input directly from a digital camera 134 via a camera docking port 136 connected to the control unit 112, directly from the digital camera 134 via a cable connection 138 to the control unit 112, via a wireless connection 140 to the control unit 112, or from memory.

The output device 128 provides a final image(s) that has been subject to transformations. The output device can be a printer or other output device that provides a paper or other hard copy final image. The output device can provide a soft copy final image. Such soft copy output devices include displays and projectors. The output device can also be an output device that provides the final image(s) as a digital file. The output device can also include combinations of output, such as a printed image and a digital file on a memory unit, such as a CD or DVD which can be used in conjunction with any variety of home and portable viewing device such as a personal media player or flat screen television.

The control unit 112 provides means for processing the digital images to produce pleasing looking images on the intended output device or media. The control unit 112 can be used to process digital images to make adjustments for overall brightness, tone scale, image structure, etc. of digital images in a manner such that a pleasing looking image is produced by an image output device. Those skilled in the art will recognize that the present invention is not limited to just these mentioned image processing functions.

Referring to FIGS. 2-3, in particular embodiments, the system is or includes a camera that has a body, which provides structural support and protection for other components. An electronic image capture unit (not shown), which is mounted in the body, has a taking lens and an electronic array image sensor aligned with the taking lens. In the capture unit, captured electronic images from the image sensor are amplified, converted from analog to digital, and processed to provide one or more image records.

The camera has a user interface, which provides outputs to the photographer and receives photographer inputs. The user interface includes one or more user input controls (labeled “user inputs” in FIG. 3) and an image display. User input controls can include a shutter release, a zoom in/out control that controls the zooming of the lens units, and other user controls. User input controls can be provided in the form of a combination of buttons, rocker switches, joysticks, rotary dials, touch screens, microphones and processors employing voice recognition responsive to user initiated auditory commands, microphones and processors employing voice recognition responsive to user initiated auditory commands, and the like. The user interface can include user reaction tracking features, such as an image sensor, a galvanic response sensor, the above-mentioned microphone. These features can store unanalyzed information for later analysis or a module capable of analyzing user responses and generating appropriate metadata can be included in the user interface. U.S. Patent Publication No. 2003/0128389 A1, filed by Matraszek et al., discusses the generation of metadata from user reaction tracking.

The user interface can include one or more information displays to present camera information to the photographer, such as exposure level, exposures remaining, battery state, flash state, and the like. The image display can instead or additionally also be used to display non-image information, such as camera settings. For example, a graphical user interface (GUI) can be provided, including menus presenting option selections and review modes for examining captured images. Both the image display and a digital viewfinder display (not illustrated) can provide the same functions and one or the other can be eliminated. The camera can include a speaker and/or microphone (not shown), to receive audio inputs and provide audio outputs.

The camera assesses ambient lighting and/or other conditions and determines scene parameters, such as shutter speeds and diaphragm settings using the imager and/or other sensors. The image display produces a light image (also referred to here as a “display image”) that is viewed by the user.

The control unit controls or adjusts the exposure regulating elements and other camera components, facilitates transfer of images and other signals, and performs processing related to the images. The control unit includes support features, such as a system controller, timing generator, analog signal processor, A/D converter, digital signal processor, and dedicated memory. As with the control units earlier discussed, the control unit can be provided by a single physical device or by a larger number of separate components. For example, the control unit can take the form of an appropriately configured microcomputer, such as an embedded microprocessor having RAM for data manipulation and general program execution. The timing generator supplies control signals for all electronic components in timing relationship. The components of the user interface are connected to the control unit and function by means of executed software programs. The control unit also operates the other components, including drivers and memories.

The camera can include other components to provide information supplemental to captured image information. Examples of such components are an orientation sensor, a real time clock, a global positioning system receiver, and a keypad or other entry device for entry of user captions or other information.

The method and apparatus herein can include features provided by software and/or hardware components that utilize various data detection and reduction techniques, such as face detection, skin detection, people detection, other object detection, for interpreting the scene depicted on an image, for example, a birthday cake for birthday party pictures, or characterizing the image, such as in the case of medical images capturing specific body parts.

It will be understood that the circuits shown and described can be modified in a variety of ways well known to those of skill in the art. It will also be understood that the various features described here in terms of physical circuits can be alternatively provided as firmware or software functions or a combination of the two. Likewise, components illustrated as separate units herein may be conveniently combined or shared. Multiple components can be provided in distributed locations.

Image records may be subject to automated pattern classification. It will be understood that the invention is not limited in relation to specific technologies used for these purposes, except as specifically indicated. For example, pattern classification can be provided by any of the following, individually or in combination: rule based systems, semantic knowledge network approaches, frame-based knowledge systems, neural networks, fuzzy-logic based systems, genetic algorithm mechanisms, and heuristics-based systems.

A digital image includes one or more digital image channels or color components. Each digital image channel is a two-dimensional array of pixels. Each pixel value relates to the amount of light received by the imaging capture device corresponding to the physical region of pixel. For color imaging applications, a digital image will often consist of red, green, and blue digital image channels. Motion imaging applications can be thought of as a sequence of digital images. Those skilled in the art will recognize that the present invention can be applied to, but is not limited to, a digital image channel for any of the herein-mentioned applications. Although a digital image channel is described as a two dimensional array of pixel values arranged by rows and columns, those skilled in the art will recognize that the present invention can be applied to non-rectilinear arrays with equal effect.

It should also be noted that the present invention can be implemented in a combination of software and/or hardware and is not limited to devices, which are physically connected and/or located within the same physical location. One or more of the devices illustrated in FIGS. 2 and 3 can be located remotely and can be connected via a network. One or more of the devices can be connected wirelessly, such as by a radio-frequency link, either directly or via a network.

The present invention may be employed in a variety of user contexts and environments. Exemplary contexts and environments include, without limitation, wholesale imaging services, retail imaging services, use on desktop home and business computers, use on kiosks, use on mobile devices, and use as a service offered via a network, such as the Internet or a cellular communication network.

Portable display devices, such as DVD players, personal digital assistants (PDA's), cameras, and cell phones can have features necessary to practice the invention. Other features are well known to those of skill in the art. In the following, cameras are sometimes referred to as still cameras and video cameras. It will be understood that the respective terms are inclusive of both dedicated still and video cameras and of combination still/video cameras, as used for the respective still or video capture function. It will also be understood that the camera can include any of a wide variety of features not discussed in detail herein, such as, detachable and interchangeable lenses and multiple capture units. The camera can be portable or fixed in position and can provide one or more other functions related or unrelated to imaging. For example, the camera can be a cell phone camera or can provide communication functions in some other manner. Likewise, the system can take the form of a portable computer, an editing studio, a kiosk, or other non-portable apparatus.

In each context, the invention may stand alone or may be a component of a larger system solution. Furthermore, human interfaces, e.g., the scanning or input, the digital processing, the display to a user, the input of user requests or processing instructions (if needed), the output, can each be on the same or different devices and physical locations, and communication between the devices and locations can be via public or private network connections, or media based communication. Where consistent with the disclosure of the present invention, the method of the invention can be fully automatic, may have user input (be fully or partially manual), may have user or operator review to accept/reject the result, or may be assisted by metadata (metadata that may be user supplied, supplied by a measuring device (e.g. in a camera), or determined by an algorithm). Moreover, the algorithm(s) may interface with a variety of workflow user interface schemes.

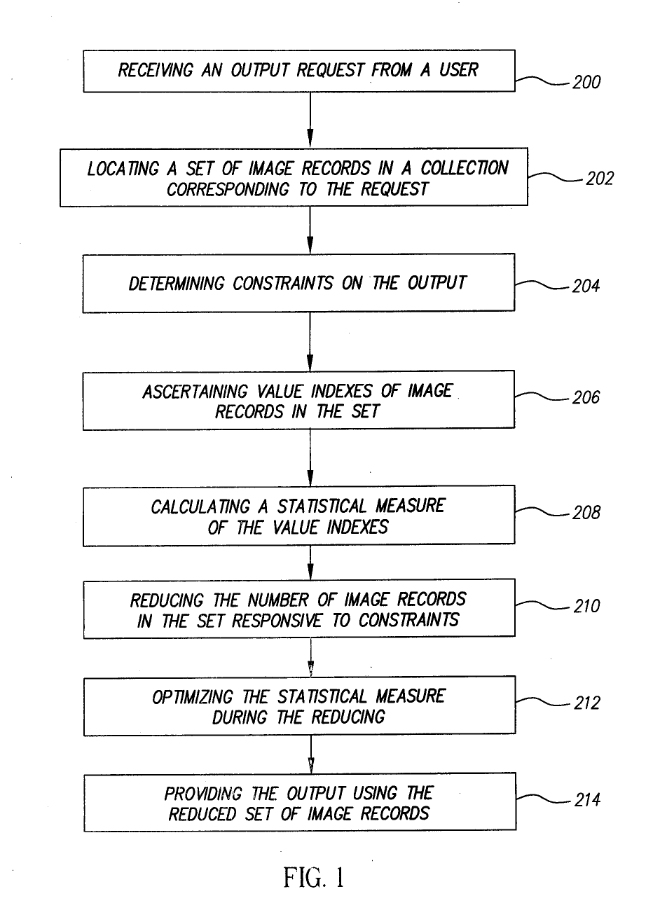

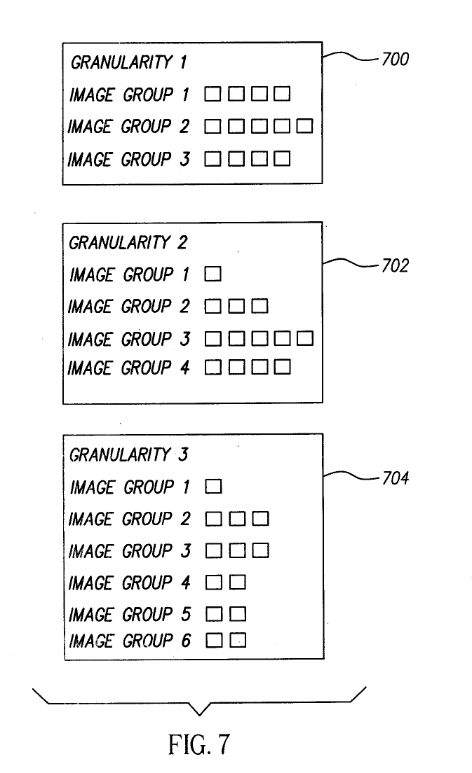

Referring to FIGS. 1 and 4-7, in the method, output is supplied from a collection 400 in response to receipt (200) of an output request from a user. The output is from a set of image records 402 corresponding to the request, but the number of image records supplied is reduced relative to that set of image records, without human intervention, based on performance of an optimization routine 414 on constraints 412 on the output and value indexes. The output 406 can be image records or a list of those records or the product of a function performed on the records or the list. The output can be, for example, in a form suitable for a display or for printing or for storage in memory. The constraints are limitations of an output device or limitations due to the user or both. FIG. 7 illustrates an example of the differences in “granularity”, that is level of detail, provided in the outputs 700, 702, 704 in response to the same request, but with three different sets of constraints.

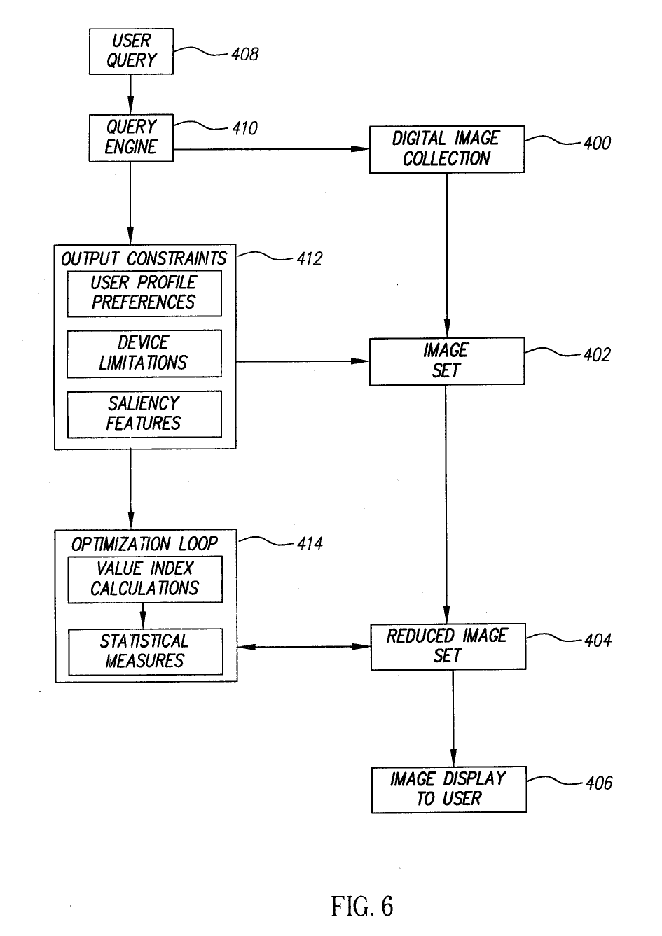

FIG. 6 shows details of a particular embodiment. The image records, in that case are limited to still images, the request 408 is presented as a query to a query engine 410, the optimization routine 414 is an optimization loop, and the output 406 is an image displayed to the user.

There is a functional relationship between the output device capability, value index of the located set of image records, and the reduced set of image records. With the same request, each device with different constraints will have a different functional relationship and a different reduced set of image records will be provided. For example, a limited bandwidth or hardware limited device, can receive a reduced set of ten still images and a less constrained device, a reduced set of a hundred images in response to the same request to the same collection.

Referring to FIG. 1, after the request is received (200), a set of image records in the collection that correspond to the request are located (202). The request conforms with the input requirements of a particular system, but beyond that, the manner in which the request is presented is not critical. For example, the request can be initiated by the user actuating a preset category listed in a menu using a mouse or the like or can type in a natural language or program specific request or can vocalize a request using speech recognition. The form of the request likewise conforms with the logical processing capabilities of the system, but is otherwise not critical. Search routines are well known to those of skill in the art and it is not critical how the collection is searched to locate the set of image records. As a simple example, a request can ask for the set of image records having metadata including a specified alphanumeric string. In another example, the set of image records meeting the request are supplied via database software, by presenting the request as a query meeting the requirements of the database software. In another example, the set of image records meeting the request is determined using classification software operating by one or more pattern recognition techniques.

In response to the request, one or more constraints on the output are determined (204). The constraints are limitations of the overall system or user preferences. The system limitations are what the system can and cannot do in response to a particular request due to what equipment is available and the limitations of that equipment. Examples of physical limitations include: available bandwidth and communication path, limitations in output device hardware and software capabilities, limitations in user input capabilities.

The user preferences are additional limitations imposed by the user and/or operator of the system. Examples of user preferences include one or more of: a preferred playback device, a preferred maximum output delay, preferred characteristics of the image records in the output, and preferred characteristics of the images and/or other information in the output. The user preferences can operate in different ways. For example, user preferences can be associated with a collection, or with all requests from a particular user, or with a particular request. User preferences can be provided, in some embodiments, by initially asking the user for preferences or by tracking usage and modifying default constraints based on the usage.

The output and constraints can be explicitly designated in a request, but are more likely, at least in part, to be inherent in a particular request. Default output and constraints can also be predefined so that output can be provided even if a request is ambiguous. An example of an explicit constraint is a request that includes a command to print the output on a single page of A4 paper or a command to preview that output. Another example of an explicit constraint is request from a cell phone camera that includes a specification of the available display resolution. Inherent constraints are not specified directly in the request, but are specified indirectly as a general user preference or are required due to unavailability of any other alternatives or of a superior alternative in a predefined hierarchy. An example of an inherent constraint is a bandwidth limitation of a request submitted via a two-way dial-up Internet connection, for delivery of image records in digital form over that connection. Examples of defaults are use of a particular output device and communications path.

Explicit constraints can be presented in the form of an identification of a particular output device. A look-up table can be provided relating the output device to its actual constraints. Inherent constraints can be determined by use of predefined look-up tables relating available output devices to specific indicia in a particular request. For example, a request having routing information indicating use of a cell phone network and the Internet can be preassigned to an image resolution appropriate for the constraints imposed by the bandwidth limitations of the communication network and the available resolution of a cell phone display. A request received via a high bandwidth network likewise has different routing information appropriate for different constraints. Information that is not otherwise known, can be provided by user preferences or defaults.

An example of a user preference is a preferred device or hierarchy of preferred devices for playback, such as: a camera phone, a desktop computer, a personal digital assistant, a portable display unit, and a television. Other examples are an intent for image usage, such as viewing image records, creating output, searching image records, browsing image records, and purchasing image records; and social patterns using images, such as: use of user contact lists, group sharing, individual sharing. Each intent or social pattern can be communicated in a request or can be imputed from characteristics of the request and can be preassociated with limitations on the output. Some user preferences can function like output device constraints. For example, a user can define maximum acceptable delays in presentation of a first image record and following image records, a minimum acceptable image resolution and hardcopy output characteristics.

Individual preferences can be applied globally or can be applicable to particular output devices or to specific uses. For example, a user preference can specify different minimum speeds required to present images for each of a plurality of different display devices available to the user or for use of the same device connected by broadband communication network or by a local wireless connection, such as Wi-Fi (IEEE 902.11 (a)).

User preferences can be accumulated and stored in a user profile. A system can include different user profiles to individualize the system for different users. The user profile can be transferable independent of the collection, so that the user profile can be ported to different output devices within a system or to another system and can either operate in the same manner in all devices or can be device-dependent, as desired. In the latter case, the user profile has a plurality of different sets of user preferences, each set being applicable to a different one of a plurality of output devices.

The set of image records located in the collection is reduced by sampling as described in the following. User preferences can define relative sampling rates for different output devices or different uses. For example, a user can provide user preferences for a first, relatively low sampling rate for output to a digital camera to allow relatively quick sharing of displayed output images and for a second, relatively high sampling rate for output used to create a photo memorial of another person's life.

Referring to FIG. 1, a value index is ascertained (206) for each of the image records in the located set. The value indexes can be predetermined, in which case the respective value indexes are read from image record metadata. Value indexes can also be calculated as needed. Since a collection can have some images with predetermined value indexes and others without, many requests may require both approaches. Determined value indexes can be saved as metadata of the respective image records to reduce computational requirements of future requests.

The value index is intended to provide relative values of each of the image records in the located set to an intended user. The value index can be based on an earlier user evaluation of individual image records. This approach is cumbersome and it is preferable to use a value index that can be determined without user intervention or with optional user intervention. A large number of different types of value index are known to those of skill in the art. The value index can be any of those disclosed or discussed in U.S. patent application Ser. No. 11/403,686, filed 13 Apr. 2006, by Elena A. Fedorovskaya, et al., entitled “VALUE INDEX FROM INCOMPLETE DATA” and in U.S. patent application Ser. No. 11/403,583, filed Apr. 13, 2006, by Joseph A. Manico, et al., entitled “CAMERA USER INPUT BASED IMAGE VALUE INDEX”, both of which are hereby incorporated herein by reference. The value index can also be based on or derived from any of the information used in creating the value indexes in those patent applications and any combinations thereof. An example of a derived parameter is events and sub-events, determined in one of the ways known to those of skill in the art, such as disclosed in U.S. patent application Ser. No. 11/197,243, filed 4 Aug. 2005, by Bryan D. Kraus, et al., entitled “MULTI-TIERED IMAGE CLUSTERING BY EVENT”, which is hereby incorporated herein by reference. A particular value index can be preselected based on an expectation of particular users. A user can also be given a choice of a particular value index as a part of setting user preferences.

A value index can be customized by a user in setting user preferences. This customization can replace or modify the value index. In the latter case, the read or calculated value indexes are modified by a further calculation to provide modified value indexes that are then used in the determining the reduced set of image records. The advantage of this approach is the unmodified value indexes can be retained in metadata for other uses. In a particular embodiment, the modification revalues the image records based one or more or combination of metadata associated with the image records, user preferences, and saliency features of the image records of the set.

The collection and usage of metadata relating to image records is well known in the art. Suitable metadata for modifying the value index can be selected based on availability and relevance to the user. Particularly useful types of metadata include: capture metadata relating to conditions at the time of image capture, and usage metadata relating to usage of a particular image or group of images following capture.

Capture metadata is data available at the time of capture that defines capture conditions, such as exposure, location, date-time, status of camera functions, and the like. Examples of capture metadata include: spatiotemporal information, such as timestamps and geolocation information like GPS data; camera settings, such as focal length, focus distance, flash usage, shutter speed, lens aperture, exposure time, digital/optical zoom status, and camera mode (such as portrait mode or sports/action mode); image size; identification of the photographer; textual or verbal annotations provided at capture; detected subject(s) distance; flash fired state.

Capture metadata relates to both set up and capture of an image record and can also relate to on-camera review of the image record. Capture metadata can be derived from user inputs to a camera or other capture device. Examples of user inputs include: partial shutter button depression, full shutter button depression, focal length selection, camera display actuation, selection of editing parameters, user classification of an image record, and camera display deactuation. The viewfinder-display controls can include one or more user controls for manual user classification of images, for example, a “share” or “favorite” button. Metadata based on user inputs can include inputs received during composition, capture, and, optionally, during viewing of an image record. If several images are taken of the same scene or with slight shifts in scene (for example as determined by a subject tracking autofocus system and the recorded time/date of each image), then information datas related to all of the images can be used in deriving the capture metadata of each of the images.

Another example of capture metadata is temporal values calculated from temporal relationships between two or more of the camera inputs. Temporal relationships can be elapsed times between two inputs or events occurring within a particular span of time. Examples are inputs defining one or more of: image composition time, S1-S2 stroke time, on-camera editing time, on-camera viewing time, and elapsed time at a particular location (determined by a global positioning system receiver in the camera or the like) with the camera in a power on state. Temporal relationships can be selected so as to all exemplify additional effort on the part of the user to capture a particular image or sequence of images. Geographic relationships between two or more inputs can yield information datas in the same manner as temporal relationships as can combinations of different kinds of relationships, such as inputs within a particular time span and geographic range.

Other examples of capture related image data include information derived from textual or vocal annotation that is retained with the image record, location information, current date-time, photographer identity. Such data can be entered by the user or automatically. Annotations can be provided individually by a user or can be generated from information content or preset information. For example, a camera can automatically generate the caption “Home” at a selected geographic location or a user can add the same caption. Suitable hardware and software for determining location information, such as Global Positioning System units are well known to those of skill in the art. Photographer identity can be determined by such means as: use of an identifying transponder, such as a radio frequency identification device, user entry of identification data, voice recognition, or biometric identification, such as user's facial recognition or fingerprint matching. Combinations of such metadata and other parameters can be used to provide image data. For example, date-time information can be used in combination with prerecorded identifications of holidays, birthdays, or the like.

Image usage data is data relating to usage of a particular image record following capture. This data can reflect the usage itself or steps preparatory to that usage, for example, editing time prior to storage or printing of a revised image. Examples of image usage data include: editing time, viewing time, number of reviews, number of hard copies made, number of soft copies made, number of e-mails including a copy or link to the respective image record, number of recipients, usage in an album, usage in a website, usage as a screensaver, renaming, annotation, archival state, and other fulfillment usage. Examples of utilization on which the image usage data is based include: copying, storage, organizing, labeling, aggregation with other information, image processing, non-image processing computations, hard copy output, soft copy display, and non-image output. Equipment and techniques suitable for image record utilization are well known to those of skill in the art. For example, a database unit that is part of a personal computer can provide output via a display or a printer. In addition to direct usage information, usage data can include data directly comparable to the temporal values earlier discussed. For example, the time viewing and editing specific image records can be considered.

The nature and use of saliency features are discussed in U.S. Pat. No. 6,671,405, to Savakis, et al., entitled “METHOD FOR AUTOMATIC ASSESSMENT OF EMPHASIS AND APPEAL IN CONSUMER IMAGES”, which is hereby incorporated herein by reference.

Suitable saliency features include structural saliency features and semantic saliency features. Structural saliency features are physical characteristics of the images in the image records and include low-level early vision features and geometric features. The low-level early vision features include color, brightness, and texture. The geometric features include location, such as centrality; spatial relationship, such as bordemess, adjacency, surroundedness, and occlusion; size; shape; and symmetry. Other examples of structural saliency features include: image sharpness, image noise, contrast, presence/absence of dark background, scene balance, skin tone color, saturation, clipping, aliasing, and compression state. Example parameters based on such features are a numerical measure of resolution and a binary measure of the presence or absence of very low contrast in an image. Structural saliency features are derived from an analysis of the image data of an image record. Structural saliency features are related to limitations in the capture of an original scene and any subsequent changes in the captured information, and are unrelated to content.

Semantic saliency features are higher level features in the forms of key subject matters of an image. Examples of semantic saliency features include: presence/absence of people or skin or faces, number of people, gender of people, age of people, redeye, eye blink, smile expression, head size, translation problem, subject centrality, scene type (such as indoor, city, and landscape), scene uniqueness relative to other image records, presence or absence of sky, presence or absence of grass or green vegetation, presence or absence of sports equipment, presence or absence of buildings, presence or absence of animals. (“Translation problem” is defined as an incomplete representation of the main object in a scene, such as a face, or a body of the person.) For example, sunsets can be determined by an analysis of overall image color, as in U.S. Published Patent Application No. US20050147298 A1, filed by A. Gallagher et al., and portraits can be determined by face detection software, such as U.S. Published Patent Application US20040179719 A1, filed by S. Chen. The analysis of “image content”, as the term is used here, is inclusive of image composition.

Saliency features can relate only to a particular image record or can be relative to all of the image records in the collection or a particular subset of those records. Saliency features and metadata can be used in combination. For example, scene content, such the presence of candles or a wedding dress can be used with metadata to generate derived metadata indicating one of a predetermined set of event types, such as birthday, wedding, vacation, and holiday.

Referring to FIG. 1, a statistical measure is calculated (208) from the value indexes of the set. The number of image records in the set is reduced (210) responsive to the one or more constraints to provide a reduced set of image records. During the reducing, the statistical measure is optimized (212). The output is then provided (214) using the reduced set of image records. The statistical measure and optimization are selected in accordance with the constraints on the output.

The statistical measure can be selected so as to match the reduced set of image records to user expectations. Expectations can be presented in user preferences or can be assumed. Examples of statistical measures include a arithmetic mean, a median, a mode, and a variance. The optimization of these measures can be performed by iteratively deriving different potential groups of image records for the reduced set, calculating the respective statistical measures, and determining which grouping most closely approaches a predetermined preferred value of the statistical measure. For example, a preferred value of a statistical measure can be the highest value of a value index and optimization provides the grouping of image records most closely approaching that highest value.

As an alternative, the statistical measure can take the form of probabilistic rules that are used to determine a value to compare to a threshold. For example, a single rule or group of rules, and an optimization process, can be provided in the form of a Bayesian net. Suitable rules and thresholds can be determined heuristically or by use of automated classification techniques, such as use of a genetic algorithm. Use of these techniques are well known to those of skill in the art.

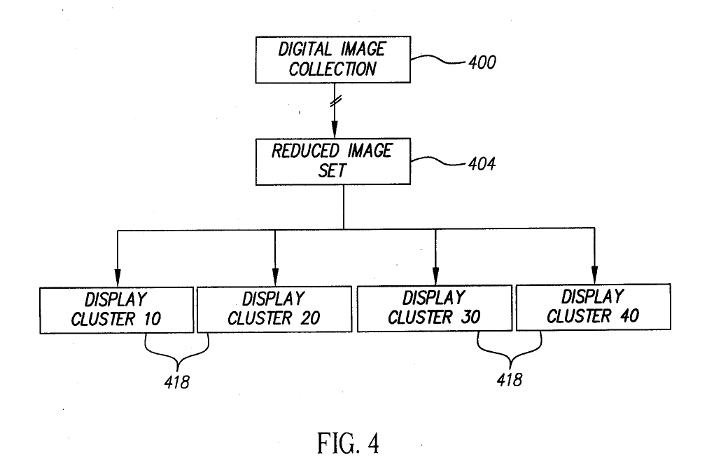

Referring to FIG. 4, as an option, the reduced set of image records 404 can be partitioned into a plurality of clusters 418 prior to being output. Examples of types of clustering techniques include: k-means clustering and hierarchical clustering. A detailed clustering technique is disclosed in U.S. Pat. No. 6,606,411, in which clustering is by events. The results of the partitioning can then be presented in the output. For example, the clusters can be designated in a list or displayed images can be grouped or other treated so as to indicate the clusters. On devices with user-input or display limitations, the number of clusters should vary based on these limitations. Some devices use input means that are limited in their navigation capabilities and contain a small screen size such as a camera phone. For these devices, more efficient browsing means are desired by the user. The number of clusters in the output should be relatively small so that the user can find a particular cluster more quickly.

As a further option, a user can be allowed to enter an additional input identifying one of the clusters in the output. A further output can then be provided identifying all of the image records in the unreduced set of image records. The parameters used to determine the partitions can be based one or more of the saliency features and metadata.

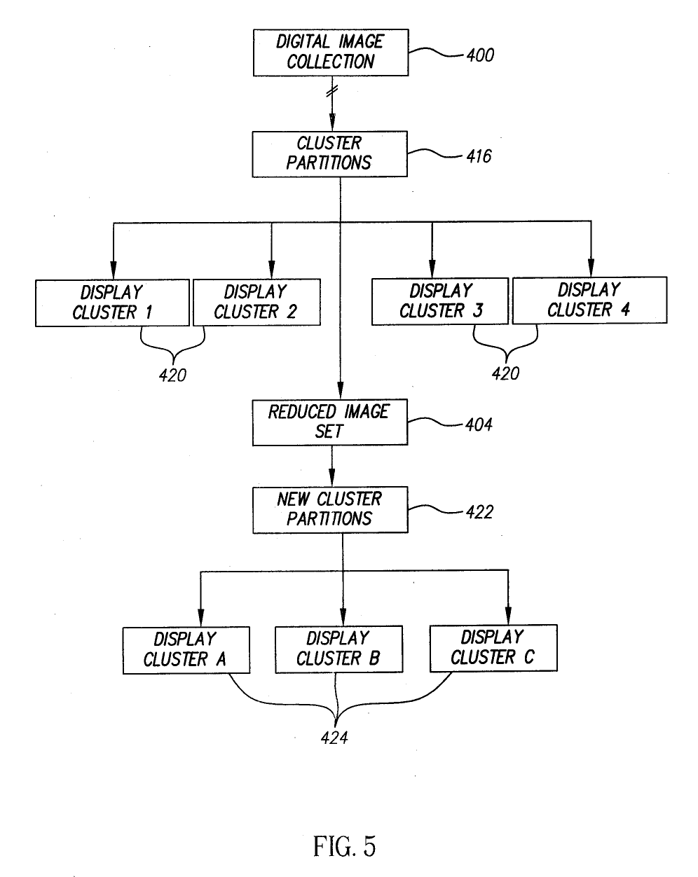

Referring to FIG. 5, the located set of image records can be partitioned (416) into clusters 420 before reduction as a part of the determination of the statistical measure. Structural and semantic saliency features, user preferences, and metadata can be used in any combination to provide the clustering. For example, a user might want to create a calendar with one image for each month. Clustering methods can be used to cluster the images into groups by month. If each calendar month contains one open slot, then the image collection should be reduced to 12 images. The optimization selects the highest value index for each month. In another example, the collection can be partitioned with respect to the semantic saliency feature of number of people into four clusters of two or more image records each having: no people, one person, two people, and three people. The total number of image records can then be reduced by selecting, as equally as possible, the index valued image records above a predetermined threshold from each cluster.

If the located set of image records was partitioned into clusters, then the reduced set of image records 404 can be repartitioned (422) into different clusters 424 during reducing. The same partitioning procedure can be used in both cases, but the results can vary depending upon the available image records. In the previous example, the partitioning might generate two clusters: 0-1 person and 2-3 persons.

An apparatus for supplying image records from a collection, the method comprising: memory holding the collection of image records; a user interface having one or more input controls and one or more output devices; a control unit operatively connected to said memory and said user interface, said control unit including: an image record locator locating a set of image records in said collection corresponding to an output request received from a user via said user interface; a constraint determiner determining one or more constraints on said output; an ascertaining unit ascertaining a respective value index of each of said image records in said set; a calculating unit calculating a statistical measure of said value indexes of said set; a reducing unit reducing in number the image records in said set responsive to said one or more constraints to provide a reduced set of image records; an optimizer optimizing said statistical measure during said reducing; and an output unit providing the output to one of said output devices using said reduced set of image records.

The invention has been described in detail with particular reference to certain preferred embodiments thereof, but it will be understood that variations and modifications can be effected within the spirit and scope of the invention.

1. A computer-mediated method for supplying image records from a collection, the method comprising:
receiving an output request from a user;
locating a set of image records in said collection corresponding to said request;
determining one or more constraints on said output;
ascertaining a respective value index of each of said image records in said set;
calculating a statistical measure of said value indexes of said set;
reducing in number the image records in said set responsive to said one or more constraints to provide a reduced set of image records;
optimizing said statistical measure during said reducing; and
providing the output using said reduced set of image records.

2. The method of claim 1 wherein said determining further comprises identifying an output device associated with said output request and said constraints include limitations of said output device.

3. The method of claim 2 wherein said constraints include a plurality of user preferences.

4. The method of claim 3 wherein said output includes one or both of hard copy output and soft copy output of said set of image records and said limitations of said output device include one or more of: limitations in hardware capabilities, limitations in user input capabilities, limitations in display capabilities, and network and communication bandwidth limitations; and said user preferences are predetermined and include one or more of: a preferred playback device, a preferred maximum output delay, and preferred characteristics of said image records in said output.

5. The method of claim 4 wherein said user preferences include a plurality of different sets of user preferences, each said set being applicable to a different one of a plurality of output devices inclusive of said identified output device.

6. The method of claim 4 wherein said user preferences are transferable in a user profile independent of said image records.

7. The method of claim 1 wherein said statistical measure is a pattern classification.

8. The method of claim 7 wherein said pattern classification is a Bayesian net.

9. The method of claim 1 further comprising partitioning said reduced set of image records into a plurality of clusters prior to providing said output.

10. The method of claim 9 further comprising:
partitioning said collection of image records into a set of clusters;
identifying in said output a subset of said clusters inclusive of said reduced set of image records;
accepting user input designating one of said identified clusters; and
identifying all of the respective records of said designated cluster in said collection, responsive to said user input.

11. The method of claim 1 further comprising:
partitioning said collection of image records into a first plurality of clusters prior to said receiving; and
partitioning said set of image records into a second plurality of clusters prior to said providing, said partitionings being algorithmically alike, said first plurality of clusters being different than said second plurality of clusters.

12. The method of claim 1 wherein said ascertaining further comprises:
reading value index metadata indicating respective value indexes of ones of said set of image records having said value index metadata; and
calculating the respective value indexes of other ones of said set of image records lacking said value index metadata.

13. The method of claim 1 wherein said ascertaining further comprises:
determining value index metadata indicating respective value indexes of said image records of said set;
computing one or more saliency features of respective said image records of said set;
modifying respective said value indexes responsive to respective said saliency features to provide modified value indexes; and
using said modified value indexes in said calculating and optimizing.

14. The method of claim 13 wherein said one or more saliency features include structural saliency features and semantic saliency features.

15. The method of claim 14 wherein said structural saliency features include more one or more of: color, brightness, texture, centrality, borderness, adjacency, surroundedness, occlusion, size, shape, and symmetry, image sharpness, image noise, contrast, presence or absence of dark background, scene balance, skin tone color, saturation, clipping, aliasing, and compression state; and said semantic saliency features include one or more of: presence/absence of people or skin or faces, number of people, gender of people, age of people, redeye, eye blink, smile expression, head size, translation problem, subject centrality, scene type (such as indoor, city, and landscape), scene uniqueness relative to other image records, presence or absence of sky, presence or absence of grass or green vegetation, presence or absence of sports equipment, presence or absence of buildings, presence or absence of animals.

16. The method of claim 13 further comprising reading metadata associated with the image records of said set and wherein said modifying respective said value indexes is responsive to respective said saliency features and to said metadata.

17. The method of claim 16 wherein said metadata is one of capture related metadata and usage metadata.

18. An apparatus for supplying image records from a collection, the method comprising:
memory holding the collection of image records;
a user interface having one or more input controls and one or more output devices;
a control unit operatively connected to said memory and said user interface, said control unit including:
a component locating a set of image records in said collection corresponding to an output request received from a user via said user interface;
a component determining one or more constraints on said output;
a component ascertaining a respective value index of each of said image records in said set;
a component calculating a statistical measure of said value indexes of said set;
a component reducing in number the image records in said set responsive to said one or more constraints to provide a reduced set of image records;
a component optimizing said statistical measure during said reducing; and
a component providing the output to one of said output devices using said reduced set of image records.
